(19) United States
(12) Patent Application Publication
(10) Pub. No.: US 2007/0280453 A1
(43) Pub. Date: Dec. 6, 2007

(54) METHOD AND SYSTEM TO PROVIDE ACCESS NETWORK INFORMATION TO A SERVICE

(75) Inventors: Sean S. Kelley, Barrington, IL (US); John M. Harris, Chicago, IL (US); Johanna A. Wild, Muenchen (DE)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/420,848

(22) Filed: May 30, 2006

(51) Int. Cl. H04M 3/42

(52) U.S. Cl. 379/201.01

(57) ABSTRACT

A system (100) and method (200) is provided to customize services (150). The method can include conveying (204) access network information from a user device to a core network using a SIP message, and adapting (206) a service provided by the core network according to the access network information contained in the SIP message. The method can include creating a header field to convey the access network information. A roaming status indictor can be included in a SIP SUBSCRIBE, a SIP INVITE, a SIP MESSAGE or a SIP REGISTER for adapting the delivery of presence state information concerning a resource.

### FIELD OF THE INVENTION

The embodiments herein relate generally to wireless networks and more particularly to methods and systems that offer services.

### BACKGROUND

The use of portable electronic devices and mobile communication devices has increased dramatically in recent years. Mobile communications have historically been conducted over cellular infrastructure systems, though recently they have rapidly migrated towards packet based and wireless based networks to support multimedia applications. Mobile devices generally communicate over the cellular infrastructure which can be a circuit switched or packet based network. However, a mobile device can also communicate with an access point to transmit and receive data over a wireless network such as IEEE 802.11 which can provide services such as internet, email, and voice over IP. A Wireless Local Area Network (WLAN) system deploys access points to communicate with a device within a local coverage area. WLANs and associated devices can communicate using Session Initiated Protocol (SIP) for providing features of seamless mobility. WLAN and cellular communication technologies are rapidly merging to provide seamless integrated services.

SIP is an application layer protocol for creating, modifying, and terminating sessions with one or more participants. SIP is generally used to establish an internet session and negotiate the capabilities of the session. The sessions can include internet telephone calls, multimedia distribution, and multimedia conferences. In general, SIP invitations are used to create sessions, where the invitations carry session descriptions that allow participants to agree on a set of compatible media types. Accordingly, SIP as a media transport protocol, is also particularly well suited for use as a presence protocol. SIP location services already contain presence information, in the form of registrations. Furthermore, SIP networks are capable of routing requests from any user on the network to the server that holds the registration state for a user.

Presence, also known as presence information, conveys the ability and willingness of a user to communicate across a set of devices. Specification RFC2778 defines a model and terminology for describing systems that provide presence information. In that model, a presence service is a system that accepts, stores, and distributes presence information to interested parties, called watchers. In general, a presence protocol is a protocol for providing a presence service over the Internet or any IP network.

Applications and services running atop the wireless network are unaware of event data from the underlying networks. Accordingly, Access Network (AN) related events are generally not available to services and/or applications when running in an IP Multimedia Subsystem (IMS), and/or Session Initiated Protocol (SIP)/IP core network environment. The core network can be considered a packet based, IMS enabled SIP/IP environment for services and/or applications. Most IP-based (Internet Protocol) services and applications are network technology agnostic, and have no access to AN events and data when using existing architectures and protocols. Accordingly, services and applications running in a SIP/IP environment are not able to receive AN-related event and data information in their operation. A need therefore exists to provide AN-related events and data to the Services and Application Layer.

### SUMMARY

The embodiments of the invention concern a method and system for conveying access network event and data information from a user device to an entity within the core network, and using the information to adapt or customize services offered by the network. In one aspect, a header field can be created in a SIP message to convey the access network information to the network. Access network information can include a roaming status, a call quality statistic, a quality of service, an inter-technology handover indication, an RF loss history indicator, a signal strength indicator for each RF technology, a mobility or handoff rate indicator, battery life, a background audible noise indication, or a coverage transition indication. For example, the header field can include the roaming status within a SIP SUBSCRIBE message for requesting state information about a resource. In another arrangement, the header field can include the roaming status within a SIP REGISTER, SIP INVITE, SIP REFER, SIP UPDATE, SIP MESSAGE or a SIP SUBSCRIBE message. The access network information can also be a link level quality indication based on measured data or estimated conditions for the expected duration of the session. Consequently, the network can optimize a service behavior according to the recently provided access network information.

In one arrangement, a roaming condition can be identified, and if so, a service can be adapted based on a profile. For example, the profile can include a first set of requested features and behaviors associated with a home network, and a second set of requested features and behaviors associated with a roaming condition. The requested features and behaviors describe which services are required by the user or allowed by the operator during roaming and how the services should operate. In one example, a roaming status can be included in a SIP REGISTER message to increase a re-registration timer. In another example, a delivery time of information can be adjusted to reduce network resource utilization. This can include disabling and enabling an optional feature such as group advertisement or personal alert. This can also include accepting and rejecting a subscription to participant information.

Embodiments of the invention also concern a method for managing information traffic while roaming. The method can include identifying a profile associated with a roaming condition based on a trigger, and adjusting a delivery of media according to the profile. Upon exiting the roaming condition, the delivery of media can be restored according to a profile associated with a home network condition. In one arrangement, the delivery of media can be filtered, delayed or aggregated during the roaming. A charging can be updated in accordance with the delivery of media. The charging describes the service costs associated with using the device during roaming or within a home network to receive information.

Embodiments of the invention also concern a header field for a SIP message. The header defines one of a roaming status, a call quality statistic, a quality of service, an inter-technology handover, a coverage transition indication, and a link level quality indication to convey access network information to adapt services. The link level quality indication can be based on measured data and estimated conditions for an expected duration of a session. The SIP message can be a SIP REGISTER message for registering for IMS services. Alternatively, the SIP message can be a SIP SUBSCRIBE message for subscribing to a resource.

Embodiments of the invention also concern a method for managing presence traffic. The method can include subscribing to a resource that provides presence information through a presence service, receiving notifications from the service to update the presence information, providing access network information associated with a delivery of the presence information to the service, and adapting the service according to the network information for managing presence information traffic. The access network information is provided by including a header field in one of a SIP REGISTER, SIP INVITE, SIP REFER, SIP UPDATE, SIP NOTIFY, SIP MESSAGE and a SIP SUBSCRIBE message.

### BRIEF DESCRIPTION OF THE DRAWINGS

The features of the system, which are believed to be novel, are set forth with particularity in the appended claims. The embodiments herein, can be understood by reference to the following description, taken in conjunction with the accompanying drawings, in the several figures of which like reference numerals identify like elements, and in which:

FIG. 1 illustrates a communications network in accordance with an embodiment of the inventive arrangements;

FIG. 2 presents a method for providing access network information to a service entity within the core network using SIP headers in accordance with an embodiment of the inventive arrangements;

FIG. 3 presents an method for conveying access network information during roaming in accordance with an embodiment of the inventive arrangements;

FIG. 4 presents a method for charging based on a profile in accordance with an embodiment of the inventive arrangements; and

FIG. 5 presents a method for managing presence traffic in accordance with an embodiment of the inventive arrangements.

### ACRONYMS

AN—Access Network
AP—Access Point
IMS—IP Multimedia Subsystem
S-CSCF—Serving Call Session Control Function
SIP—Session Initiated Protocol
WLAN—Wireless local area networks
XDMS—XML Document Manage Server
XML—Extensible Markup Language

### DETAILED DESCRIPTION

While the specification concludes with claims defining the features of the embodiments of the invention that are regarded as novel, it is believed that the method, system, and other embodiments will be better understood from a consideration of the following description in conjunction with the drawing figures, in which like reference numerals are carried forward.

As required, detailed embodiments of the present method and system are disclosed herein. However, it is to be understood that the disclosed embodiments are merely exemplary, which can be embodied in various forms. Therefore, specific structural and functional details disclosed herein are not to be interpreted as limiting, but merely as a basis for the claims and as a representative basis for teaching one skilled in the art to variously employ the embodiments of the present invention in virtually any appropriately detailed structure. Further, the terms and phrases used herein are not intended to be limiting but rather to provide an understandable description of the embodiment herein.

The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically. The term “suppressing” can be defined as reducing or removing, either partially or completely. The term “processing” can be defined as number of suitable processors, controllers, units, or the like that carry out a pre-programmed or programmed set of instructions.

The terms “program,” “software application,” and the like as used herein, are defined as a sequence of instructions designed for execution on a computer system. A program, computer program, or software application may include a subroutine, a function, a procedure, an object method, an object implementation, an executable application, an applet, a servlet, a source code, an object code, a shared library/dynamic load library and/or other sequence of instructions designed for execution on a computer system.

Embodiments of the invention concern a system for providing access network information to a service and application layer using a SIP header. New headers can be defined for SIP messages which can include REGISTER, INVITE, MESSAGE, REFER, UPDATE, NOTIFY and SUBSCRIBE. The SIP messages convey Access Network (AN) information, such as AN events including inter-technology handover and in/out-of-coverage events, and AN-related data such as Link Level Quality indications and roaming status. Application Servers such as a PoC Server or a Presence Server can receive the SIP messages and adapt a service or application based on the AN-related information.

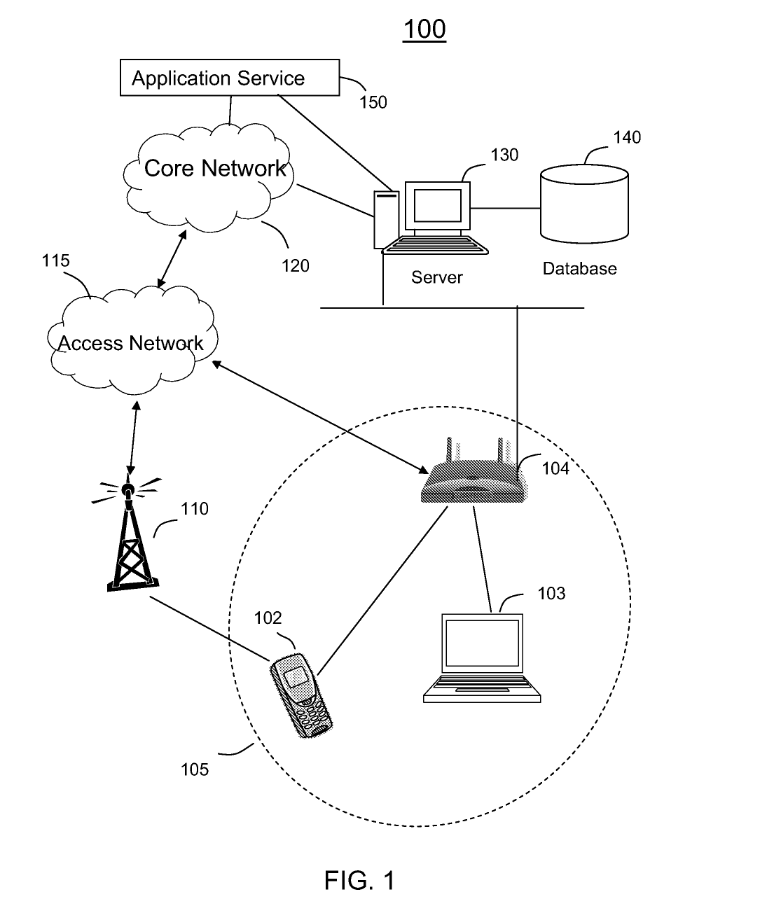

Referring to FIG. 1, a mobile communication environment 100 is shown. The communication environment 100 can provide wireless connectivity over a radio frequency (RF) communication network or a Wireless Local Area Network (WLAN). In one arrangement, the user device 102 can communicate with a base transceiver station (BTS) 110 in a cellular communication system using a standard communication protocol such as CDMA, GSM, or iDEN. The BTS 110 connects the user device 102 to an Access Network (AN) 115. The AN 115 is access technology specific and controls the communication interface used by the user device 102 (e.g. air interface). The user device can be a PDA, a mobile phone, a cable modem, a multimedia device and a PC, but is not herein limited to these. The user device 102 can comprise an application client, which can also be represented by a proxy (not shown) in the network. Embodiments of the invention are not herein limited to a mobile communication environment. Embodiments of the invention are also directed to landline communication systems, cable access networks, and the like. For example, a user can subscribe to presence information from a mobile phone while driving, or through a cable access network while at home. The BTS 110, in turn, can connect the user device 102 to an IMS enabled SIP/IP Core Network (or an equivalent IP Network) 120 over a packet switched link. The Core Network 120 can support application services and service layers 150 for providing media or content to the user device 102. The user device 102 can also connect to other communication devices through the Core Network 120 using a wireless communication channel. The user device 102 can establish connections with an application server 130 on the network and with other user devices for exchanging information. The server 130 can have access to a database 140 that is stored locally or remotely and which can contain profile data. The server can also host application services directly, or over the application service layer 150. In one arrangement, the server 130 can be a presence server for accepting and distributing presence data.

The user device 102 can also connect to the Core Network 120 over a WLAN access point 104 via the AN 115. WLANs provide wireless access to the mobile communication environment 100 within a local geographical area 105. WLANs can also complement loading on a cellular system, so as to increase capacity. WLANs are typically composed of a cluster of Access Points (APs) 104 (only one shown) also known as base stations. The mobile communication device 102 can communicate with other WLAN devices such as a laptop 103 within the base station area 105. In typical WLAN implementations, the physical layer uses a variety of technologies such as 802.11b or 802.11g WLAN technologies. The physical layer may use infrared, frequency hopping spread spectrum in the 2.4 GHz Band, or direct sequence spread spectrum in the 2.4 GHz Band. The user device 102 can send/receive data to/from the server 130 or other remote servers on the mobile communication environment 100. In one example, the user device 102 can send/receive images to/from the database 140 through the server 130.

The server 130 can communicate with the user device 102 through Session Initiated Protocol (SIP). For example, the AP 104 can support a SIP compliant proxy, the user device 102 can be a SIP compliant client and be represented by associated SIP proxies, and the server 130 can be a SIP compliant server. Other user devices that enter the wireless network can also provide SIP compliance to communicate data with the other SIP compliant devices. The SIP server 130 can provide translation services between SIP compliant devices on different service systems. For example, when the SIP client 102 requests a connection to an IP-based destination device, the SIP server 130 can give the IP destination address directly to the SIP client 102, or establish a connection with the destination device and act as a SIP proxy.

To participate in an IP based communication session, a device registers its IP address with a SIP server. For example, a wireless device can have an associated IP address which is a unique alphanumeric packet address such as SIP:my_phone@motorola.com. When the originating client device requests a connection to another IP destination device, such as another wireless device, the SIP server 130 can provide the destination IP address to allow a direct communication session, or the SIP server can act as a proxy for passing communication between the two devices. The SIP server 130 may be able to translate addresses and provide verification services.

SIP defines a number of different requests which can include INVITE, REGISTER, OPTIONS, MESSAGE, and SUBSCRIBE but are not herein limited to these. SIP provides signaling services for establishing and negotiating a secure and unsecured sessions but does not actually provide service offerings. The SIP specification only defines an application layer control/signaling protocol to establish, modify, and terminate multimedia sessions. SIP methods and headers are defined which enable the establishment of sessions for the communication of information, such as presence, and which uses SIP as a mechanism for session control. New headers can be defined for SIP messages (REGISTER, INVITE, REFER, UPDATE, NOTIFY, MESSAGE, SUBSCRIBE, etc) to convey Access Network (AN) information, such as AN events and AN-related data to Application Servers which can receive the SIP messages and adapt service/applications based on AN information.

A P-Access-Network-Info header used in a SIP message is known in the art. The P-Access-Network-Info header is a specific type header which only conveys the type of access network (i.e. WLAN, GPRS, CDMA 2000-1x). The header does not identify relevant data for making informed decisions. It is used in practice only to convey the designated network type.

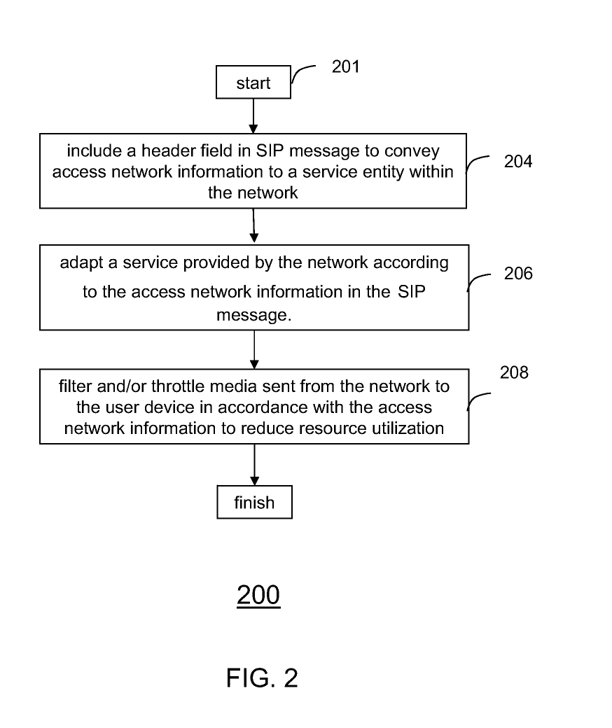

Referring to FIG. 2, a method 200 for providing access network information to a service entity within the core network using SIP headers is shown. When describing the method 200, reference will be made to FIG. 1 as an example suitable system for practicing the method 200. Moreover, the steps of the method 200 are not limited to the particular order in which they are presented in FIG. 2. The inventive method can have a greater number of steps or a fewer number of steps than those shown in FIG. 2.

At step 201, the method can begin. At step 204, access network information can be conveyed from a user device to a service entity within the core network through a SIP message. The access network information can be included in the message by the user device itself or the access network information can be inserted in the message by a proxy acting on behalf of the user device. Referring to FIG. 1, the user device can be the mobile communication device 102 and the service entity within the core network can be the server 130. For example, a header field can be included in a SIP message to convey access network information to the service entity within the core network. Access network information can include AN events and AN-related data. For example, referring to FIG. 1, the user device 102 can create a header that provides access network information which can be transmitted in a SIP message via the wireless network 104 to the server 130. The header identifies the SIP message as having additional entries specifying access network information. The additional entries contain data which can be processed by the receiving entity within the core network.

Access Network (AN) information can include AN events and AN-related data. An AN event can be an inter-technology handover or in/out-of-coverage events for a user device. For example, an inter-technology handover occurs when a device hands off from a WLAN Access Point to a cellular BTS. In contrast, an intra-technology handover occurs when a device hands off from one access point to another access point. An example of an in/out of-coverage event is when a signal strength is insufficient and/or a device falls out of communication range with a base station or tower. In contrast, AN-related data such as a Link Level Quality indication can be based on measured data and/or estimated conditions such as quality metrics for the expected duration of the session. Understandably, the user device has access to physical layer data that describes the status and quality of the communication link between the user device and a communication network, such as a cellular infrastructure or a WLAN. For example, a Radio Strength Signal Indicator, a voice quality metric generated by a vocoder, or an error correction criteria can all be used to describe the quality or sustainability of the communication link currently active and supported by the user device. AN-related data can also describe roaming status such as when the user device leaves a home network coverage area and enters a visited network coverage area.

The application may perform a number of different adaptations based on this link level quality information. For example, the mobile may predict its signal strength which it anticipates it will experience throughout the length of the call. It may base this prediction on its observed mobility or planned itinerary. It may further include information indicating a mobility level or handoff rate. The application can then use this information to determine factors like the vocoder bit rate, the voicemail greeting style, the call inactivity timer, keep alive messaging frequency, packetization, and the like.

Battery life can be used as an indicator to cause the application to do certain resource conserving activities to save battery life. A background audible noise indication may be used to cause the system to use better vocoder quality so that the system can compensate for this source of audio degradation. A handoff rate indicator may be used to impact the size of a play out buffer. If the handoff rate or mobility rate is high, it may be because there is more jitter resulting from handoffs such that a deeper playoff buffer is required.

Additionally, the message fields conveying the access network information described in the preceding paragraphs can be added to the SIP invite message. This enables the application to perform certain adaptations at the beginning of a call, for example, when deciding what vocoder bit rate to use.

At step 206, a service provided by the service entity within the core network can be adapted according to the access network information received in the SIP message from the user device. For example, referring to FIG. 1, the application server 130 can receive the SIP message and adjust its service offerings. The service offerings can be provided directly by the server 130, the Core Network 120, or the application services 150. The application server 130 can be a Push-to-Talk over Cellular (PoC) Server, an IM Server, a Content Server or a Presence Server, but is not herein limited to these. The application server 130 can also be communicatively coupled to the cellular communication system 110 and the wireless network 104 as well as other servers and devices. The header can inform the application server 130 that access network information is provided in the SIP message. The application server 130 can interpret the access network information and adapt the service behavior.

At step 208 media sent from the service entity within the core network to the user device can be filtered or throttled to reduce core network and air interface resource utilization, such as bandwidth. Throttling refers to accumulating or aggregating data over a window of time and providing the information as a collected package of data at a later time. Throttling generally incurs delays as the data is first buffered prior to transmission. Throttling can be employed to minimize disparate delivery of data and concentrate the amount of data provided at a given time. Filtering refers to suppressing or removing information that is unnecessary, redundant, or not requested. For example, data can be filtered to remove extraneous or superfluous information based on AN events. Referring to FIG. 1, the cellular communication system 110 or the wireless network 104, having received the SIP message containing AN event information, can filter and/or throttle media provided to the user device 102 in accordance with the access network information received. For example, an AN event may reveal that the user device has entered a new coverage area. Accordingly, the application server 130 hosting the application service or service layer 150 can adjust a delivery of service to the user device 102. Adjusting the delivery of service can include, for example, filtering the media to avoid sending media that the end user of the user device is not concerned with receiving in the new area, or is more costly to receive in the new area. Media that is not applicable to the new coverage area can be filtered out. By filtering the media for content, the application server 130 also reduces network resource utilization, such as bandwidth, though not herein limited to. The filtering may also reduce service costs that the end user of the device may incur for subscribing to the service. Throttling also minimizes setup time for transmitting media which may, in turn, lower service subscription costs given resource utilization. Notably, the application server 130 can adapt a service through filtering or throttling based on the access network information received in the SIP message. The adaptation of service is not limited to the delivery of service or to the methods of filtering and throttling. Various means for adapting a service are herein contemplated.

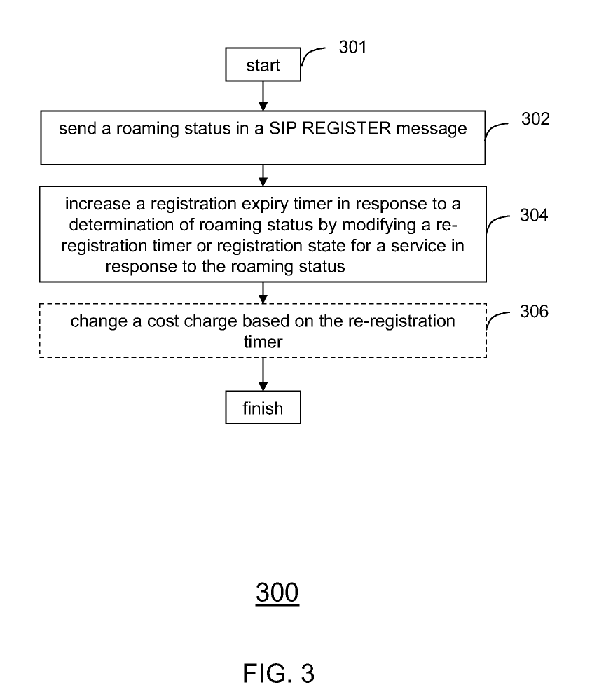

Referring to FIG. 3, an exemplary method for conveying access network information during roaming is shown. When describing the method 300, reference will be made to FIG. 1, although it must be noted that the method 300 can be practiced in any other suitable system or device. Moreover, the steps of the method 300 are not limited to the particular order in which they are presented in FIG. 3. The inventive method can have a greater number of steps or a fewer number of steps than those shown in FIG. 3.

At step 301, the method can begin in a state where a user device enters into a roaming condition. A user device can enter a roaming condition when it leaves a home network. The user device can determine that it is entering a roaming condition when it acquires an access network. It can also determine a roaming condition through identifiers that it receives which will not match its home network. Referring to FIG. 1, the user device can enter a roaming condition when it leaves the coverage area 105. At step 302, in one particular example, a roaming status can be included in a SIP REGISTER message. For example, the SIP REGISTER message can include a header that informs a system processing the SIP message that the user device is in a roaming state. A SIP REGISTER message is applicable when the user device 102 is communicating through an IMS enabled SIP/IP Core Network or an equivalent IP Network. Within the context of a user equipment such as the user device 102, the header can be defined as a header in the SIP REGISTER message which is sent to an S-CSCF (not shown) in the Core Network 120.

At step 304, a registration expiry timer can be increased in response to a determination of roaming status. The SIP REGISTER message includes a header specifying that the SIP REGISTER message contains access network information such as roaming status. For example, referring to FIG. 1, a registration expiry timer is included in the response to the REGISTER request by the server 130 performing the S-CSCF function for the user device. The registration expiry timer describes how often the user device 102 must register with the S-CSCF. The registration rate can be adjusted based on the roaming condition. The server 130 performing the S-CSCF function can process the SIP message and extract the roaming status indicator and increase or decrease a registration timer. Changing the registration timer adjusts the time between AN deliveries to the mobile device 102. The S-CSCF can also change what services are activated for the user depending on the roaming condition. For example, the S-CSCF may typically initiate a 3^{rd} party registration to a Presence Server to activate presence services for the user while in the home network. However, when the user is in a roaming condition, the S-CSCF may not initiate a 3^{rd} party registration to a Presence Server in order to deactivate presence services while the user is roaming, or may initiate a 3^{rd} party registration to a Presence Server and include the roaming status indicator so that the Presence Server may adapt the presence services accordingly, for example by reducing the presence information sent to the user while roaming. Understandably, during roaming, a user may not want to receive a full service subscription to media as the delivery of service may result in a higher cost; that is, the user is billed for service use. Accordingly, the roaming status indicates to the application service or service layer 150, that a service needs to be adapted.

At step 306, a service, such as a service cost, based on the re-registration timer can be optionally changed. Understandably, step 306 is an optional step. During roaming, the user may elect to receive less media in order to lower service costs associated with receiving the media. For example, over a PoC system, the roaming status information contained in a SIP REGISTER is sent to a PoC server. The PoC server can disable or enable optional features such as group advertisement of instant personal alerts. The PoC server can also reject subscriptions to participant information when the user device issues a roaming condition header in the SIP REGISTER message. As another example, the PoC server can deactivate automatic answer settings to avoid being charged for service costs. The SIP REGISTER message can be included in a communication over an IMS.

Alternatively, a roaming status can be included in a SIP SUBSCRIBE message when the communication is for state information about a resource, for example, XML documents maintained by an XML Document Management Server (XDMS), or for presence information maintained by a presence server. Returning back to step 302, the roaming status is included in a SIP SUBSCRIBE message. The roaming status can be used for updating a subscription to document changes or presence information. Understandably, a roaming status indictor can be included in a SIP REGISTER message (302) for IMS, or a SIP SUBSCRIBE message (502) for XDM and Presence services.

For example, referring to FIG. 1, documents can be stored on the database 140, and user devices can receive updates to changes made in the documents on the database. The SIP SUBSCRIBE message can inform the application server 130 (XDMS) to send notifications to the user device when changes are made to the document. Alternatively, the SIP SUBSCRIBE message can inform the Application Server 130 (Presence Server) to send notifications to the user device when changes are made to presence information. For example, Section 8., page 17 of the RFC 3856 specification, an excerpt of which is provided below, describes a subscription to presence information. In particular, the event header value “presence” reveals that the subscription is to presence events

```
  SUBSCRIBE sip:resource@example.com SIP/2.0
    Via: SIP/2.0/TCP
  watcherhost.example.com;branch=z9hG4bKnashds7
    To: <sip:resource@example.com>
    From: <sip:user@example.com>;tag=xfg9
    Call-ID: 2010@watcherhost.example.com
    CSeq: 17766 SUBSCRIBE
    Max-Forwards: 70
Event: presence
Accept: application/pidf+xml
Contact: <sip:user@watcherhost.example.com>
Expires: 600
Content-Length: 0
```

Accordingly, the application server 130 can adapt a service in view of the roaming status. For example, the service can be a cost of service for a subscription to XML document changes or presence information. Understandably, embodiments of the invention are not herein limited to service costs and can include any other service offerings. In response to the adapting of service, the application server 130 (i.e. presence server) can throttle NOTIFY messages while roaming, or allow only fetch operations. Presence subscriptions can be disabled; that is, automatic delivery of service can be temporarily disabled during roaming. The user, however, can manually request presence information if desired. Understandably, the change in presence subscription is to prevent a potentially costly delivery of unwanted or unsolicited information. For example, within a home network, the user may be entitled to the delivery of free media for promotional purposes. However, if the user leaves the home network and roams, the service may start to charge the user for the previously free media. Understandably, the user may want to restrict delivery of media when roaming.

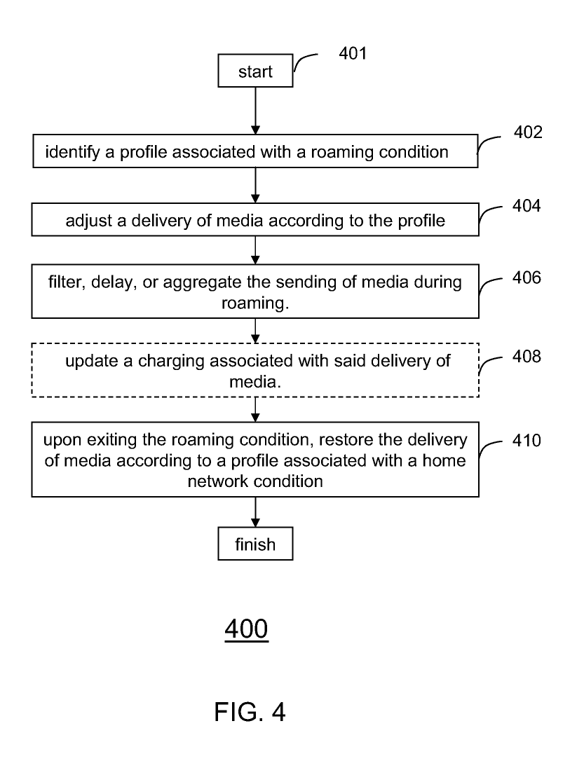

Referring to FIG. 4, an exemplary method for charging based on a profile is shown. When describing the method 400, reference will be made to FIG. 1, although it must be noted that the method 400 can be practiced in any other suitable system or device. Moreover, the steps of the method 400 are not limited to the particular order in which they are presented in FIG. 4. The inventive method can have a greater number of steps or a fewer number of steps than those shown in FIG. 4.

At step 401, the method can begin in a state wherein a user device is in a roaming condition. At step 402, a profile associated with a roaming condition can be identified. The profile, for example, provides requested features and behaviors for the delivery of services when the user device is in a roaming condition or when it is in a home network. The profile can be specific to a user, and it can describe which services to allow or block. For example, the profile can specify that the delivery of media is based on a cost structure. The profile may block calls, block media delivery, or inform a service to contact the user by another means based on a costing model. For example, referring to FIG. 1, the user device 102 may leave the coverage area 105. Accordingly, the user device 102 can send AN events through the SIP message to the application server 130, to inform the application or service layer of the recent change in roaming status. The change in roaming status may correspond to a different cost structure.

At step 404, a delivery of media according to the profile can be adjusted. For example, the application server 130 can adjust a delivery of service to the user device 102 based on the AN event information in accordance with the profile. In the case where the user is subscribing to presence information, the user may want to limit the transmission of information to avoid high service costs associated with the transmission while roaming in a visited area. Typically, a user subscribes to presence information which provides information about other users in order to base decisions on whether or not to contact the other users and what communication means to employ. Presence information can include the user's mood, the user's availability, the user's location, or the user's activity but is not herein limited to these. The user may subscribe to presence services to share this information over the network. Understandably, if the user pays for the presence service, the user can benefit financially by employing a profile for updating the level of service based on factors such as roaming condition. As an example, the user may only be interested in receiving presence information about other user's availability, but not location or other attributes which may change frequently and cause significant notifications which increase cost of service. As another example, a user may be charged for push-to-talk (PTT) when the user is roaming. The profile can indicate to the application server 130, that anyone or any entity desiring to contact the user can do so via messaging or by calling the user, such as over direct connect or interconnect. The profile can contain a description list which may be in text or XML format and which can be updated by the user, automatically over the air or through the core network.

At step 406, the sending of media can be filtered, delayed or aggregated. For example the media can be throttled or filtered to the user device. Understandably, the device provides AN event information to an Application server for allowing the application service to adjust a configuration or a service offering. For example, the AN event may signal that the device is leaving a home network and entering a roaming condition. As noted, the device can adjust a profile, such as a subscription to services, such that fewer services are provided while the device is roaming. The application service can adapt the services by filtering out information or media not specifically requested or called out by the profile. The profile reveals which services or types of presence information the user may want to share or receive with another user or an outside entity.

At step 408, a charging associated with the delivery of media can optionally be updated. Step 408 is an optional step. In one example, the application server 130, can aggregate media to consolidate the delivery of service. This can lower costs as the resource utilization is reduced and set up of dedicated access network resources occurs less frequently. The application server 130 can delay the sending of media until a threshold amount is received or a predetermined time duration has expired, and thereupon, collectively send the data to the user device. It can be appreciated, that a motivation for aggregated sending through a SIP message is to adapt a service to minimize a cost to the user or the service provider.

At step 410, upon exiting a roaming condition, delivery of media can be restored according to a profile associated with a home network condition. For example, the application service can restore services when a user establishes a home condition. Referring to FIG. 1, the user device 102 can be in a home condition when the user device is within the service area 105. The user device can enter roaming upon exiting the service area 105. The application service can adapt services based on the user's profile. The profile can be stored on the user device 102, the database 140, the application server 130, or within the application service itself. Notably, the service is adjusted in accordance with the AN events received via SIP messages.

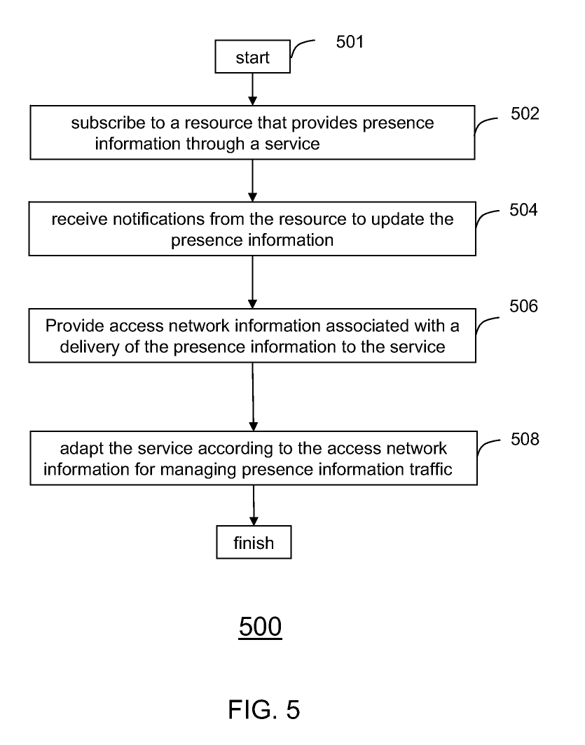

Referring to FIG. 5, a method for managing presence traffic is shown and can start at step 501. The method includes the novel aspects of the method steps presented in FIG. 4 included in the context of a presence service. At step 502, a resource can be subscribed to that provides presence information through a presence service. At step 504, notifications can be received from the presence service to update the presence information. At step 506, access network information associated with a delivery of the presence information can be provided to the presence service. At step 508, the service can be adapted according to said access network information for managing presence information traffic.

For example, a presence subscriber could subscribe to a particular resource and receive all presence information about the resource that the user is authorized to receive. The resource can be an entity or an individual and referenced by company name or personal name for example. The authorized information can be the resource's availability for communication, location, mood, activity, and the like, but is not herein limited to these. Updates can be received and provided as soon as the presence information changes. For example, some elements of presence information, such as location, may be expected to change frequently, which could lead to frequent updates. A user may also subscribe to a LIST of resources (e.g. a presence list, such as “coworkers” or “golf buddies”) and receive updates whenever any presence information for any resource in the list changes.

When roaming however, the user may be charged extra based on data traffic for providing the presence service; that is, sending and receiving data. In the case that notifications can be frequent and large in size, a user may be unknowingly charged more for the services provided when the user is roaming. Understandably, the user may be surprised to receive the next bill. Accordingly, a presence server, such as the application server 130 of FIG. 1, may store 2 profiles for the user, though more profiles may be stored particular to the user's or service provider's interest. The first profile can instruct the application server to take certain steps for delivery or service when in the home network. The second profile can instruct the application server to perform different steps or services when roaming. For example, the first profile can provide all presence information instantly. The second profile, can provide a subset (i.e. more important) of the presence information, and/or throttle the presence information to the user less frequently (i.e. aggregate over a 5 minute period). Understandably, the profiles reveal the courses of action the application services can take when relevant and recent AN event information is provided to the services.

Where applicable, the present embodiments of the invention can be realized in hardware, software or a combination of hardware and software. Any kind of computer system or other apparatus adapted for carrying out the methods described herein are suitable. A typical combination of hardware and software can be a mobile communications device with a computer program that, when being loaded and executed, can control the mobile communications device such that it carries out the methods described herein. Portions of the present method and system may also be embedded in a computer program product, which comprises all the features enabling the implementation of the methods described herein and which when loaded in a computer system, is able to carry out these methods.

While the preferred embodiments of the invention have been illustrated and described, it will be clear that the embodiments of the invention are not so limited. Numerous modifications, changes, variations, substitutions and equivalents will occur to those skilled in the art without departing from the spirit and scope of the present embodiments of the invention as defined by the appended claims.

What is claimed is:

1. A method to customize services, comprising the steps of:
conveying access network information from a user device to an entity within a core network through a SIP message; and
adapting a service provided or supported by said core network according to said access network information contained in said SIP message.

2. The method of claim 1, wherein said conveying access network information further comprises including a header field in said SIP message to convey said access network information.

3. The method of claim 2, further comprising including said header in a SIP message, wherein said access network information includes one or more of a roaming status, a call quality statistic information, a quality of service information, an inter-technology handover indication, an RF loss history indicator, a signal strength indicator for each RF technology, a mobility or handoff rate indicator, battery life, a background audible noise indication, and a coverage transition indication.

4. The method of claim 2, further comprising including said header in one of a SIP SUBSCRIBE, SIP INVITE, SIP REFER, or SIP UPDATE message for performing at least one of requesting state information concerning a resource or communicating with a service entity in the core network,
wherein said access network information includes at least one of a roaming status, a call quality statistic information, a quality of service information, an inter-technology handover indication, and a coverage transition indication.

5. The method of claim 1, wherein said adapting includes one of filtering and throttling media sent from said entity within the core network to said user device in accordance with the access network information.

6. The method of claim 1, wherein said access network information is a link level quality information based on one of measured data and estimated conditions for expected duration of session.

7. The method of claim 1, further comprising adapting said service to optimize a service behavior based on said access network information.

8. The method of claim 1, wherein said adapting comprises:
identifying a roaming condition and adapting based on a profile associated with said service and said condition,
wherein said profile includes a first set of features and behaviors associated with a home network, and a second set of features and behaviors associated with said roaming condition,
wherein said features and behaviors describe which services are required by a user or allowed by an operator during roaming and how the services operate.

9. The method of claim 3, further comprising the steps of:
sending a roaming status in a SIP REGISTER message; and
increasing a re-registration timer in response to said roaming status.

10. The method of claim 1, further comprising one of disabling and enabling an optional feature including at least one of group advertisement, personal alert, forwarding of session invitations to a media recording and storage device, condition-based incoming and outgoing session barring, incoming media barring, and filtering of media content from session invitation.

11. The method of claim 1, further comprising one of accepting and rejecting a subscription to participant information.

12. A method for managing information traffic while roaming, comprising the steps of:
identifying a profile associated with a roaming condition based on a trigger;
adjusting a delivery of media according to said profile; and
upon exiting said roaming condition, restoring said delivery of media according to a profile associated with a home network condition.

13. The method of claim 12, wherein said trigger is an indication in one of a SIP REGISTER, SIP INVITE, SIP REFER, SIP UPDATE, SIP NOTIFY, SIP MESSAGE and a SIP SUBSCRIBE.

14. The method of claim 12, further comprising one of filtering, delaying or aggregating said media during said roaming when sending said media.

15. The method of claim 12, further comprising updating a charging associated with said delivery of media.

16. A system for customizing services comprising a network element for receiving access network information from a user device through a header field in a SIP message and adapting a service supported by the network in accordance with the access network information.

17. The system of claim 16 wherein the header field defines one of a roaming status, a call quality statistic information, a quality of service information, an inter-technology handover, a coverage transition indication, and a link quality indication.

18. The system of claim 16, wherein said SIP message is a SIP REGISTER message for registering for IMS services.

19. The system of claim 16, wherein said SIP message is one of a SIP SUBSCRIBE message, SIP INVITE message, SIP REFER message, SIP UPDATE message, SIP Message message and SIP NOTIFY message.

20. A method for managing presence traffic, comprising the steps of:
subscribing to a resource that provides presence information through a presence service;
receiving notifications from said service to update said presence information;
providing access network information associated with a delivery of said presence information from said service; and
adapting said service according to said access network information for managing presence information traffic.

21. The method of claim 20, wherein providing access network information comprises including a header field in one of a SIP SUBSCRIBE, SIP INVITE, SIP REFER, SIP UPDATE, SIP NOTIFY, SIP MESSAGE and a SIP REGISTER messages.
